(19) United States
(12) Patent Application Publication
(10) Pub. No.: US 2026/0250563 A1
(43) Pub. Date: Aug. 27, 2026

(54) Two-Part High Percentage Bio-Based Polymeric Compositions

(71) Applicant: Zephyros, Inc., Romeo, MI (US)

(72) Inventors: Michael Czaplicki, Romeo, MI (US); Donald Paquet, Romeo, MI (US); Kevin Cox, Romeo, MI (US); Hamid Mortazavian, Romeo, MI (US)

(21) Appl. No.: 19/472,937

(22) PCT Filed: Apr. 25, 2024
(86) PCT No.: PCT/US2024/026217

§ 371 Date: Oct. 6, 2025

Related U.S. Application Data
(60) Provisional application No. 63/461,803, filed on Apr. 25, 2023.

(51) Int. Cl. C09J 163/00; C08G 59/34; C08G 59/36; C08G 59/38; C08G 59/40; C08K 3/32; C08K 3/36

(52) U.S. Cl. CPC C09J 163/00; C08G 59/34; C08G 59/36; C08G 59/38; C08G 59/4071; C08K 3/36; C08K 2003/329; C08K 2201/014

(57) ABSTRACT

The present teachings provide for a curable adhesive formulation comprising an A-side with one or more epoxy resins and a B-side with an acidic phosphoric constituent, wherein the adhesive includes at least 30% by weight bio-based materials.

### CLAIM OF PRIORITY

This application claims the benefit of the priority of U.S. Provisional Application No. 63/461,803, filed on Apr. 25, 2023, which is incorporated by reference herein in its entirety and for all purposes.

### FIELD

The present teachings relate to a composition having a first component and a second component. More specifically, the present teachings relate to a two-component composition with one side containing epoxide functional constituents and one side containing acidic materials comprised of one or more bio-based resins.

### BACKGROUND

Products containing bio-based additives are alternatives for manufacturers looking to reduce usage of petroleum-derived products. Petroleum-derived materials are becoming less attractive due to the uncertainty of the future supplies of petroleum derived chemicals and environmental concerns. Additionally, continual usage of petroleum-derived products may lead to further regulations regarding manufacturing and consuming petroleum-derived products as their sources deplete further. Therefore, uncertainty in future supplies, environmental concerns, and regulations have directed us to use alternative green and renewable sources with comparable properties and cost.

“Bio-based”, “biodegradable”, “recycled”, etc. are terms that are usually used in similar contexts and can be confusing to distinguish from each other. For the purposes of these teachings, bio-based will refer to organic, renewable carbon. Therefore, a percentage of bio-based content of a resin, material, etc. will refer to the percentage of organic carbon that is from a renewable source, i.e. plants. Renewable carbon is typically identified based on a material's carbon-14 content, which is a weakly radioactive isotope that is not found in petroleum-derived materials. ASTM D6866 outlines a process in which renewable carbon content is measured.

Bio-based materials such as bio-based resins have recently gained attention among researchers and manufacturers. Epichlorohydrin can be bio-based if synthesized from glycerol. Creating glycidyl ethers from bio-based epichlorohydrin and petroleum-derived alcohols/polyols commonly used in the industry allows for partially renewable resins. Bio-based materials may also be derived from grown renewable resources. Bio-based glycidyl ethers are commonly used because of their reactivity. These glycidyl ethers are the reaction of epichlorohydrin and a bio-based polyol, such as isosorbide. Bio-based polyols can also be produced from the reduction of a bio-based polyacid. Another common type of bio-based resins used are glycidyl esters, typically created from the reaction of bio-based acids and epichlorohydrin. Non glycidyl ether epoxy resins have not gained much attention from manufacturers due to their lower reactivity than glycidyl ether epoxy resins. Epoxidized bio-based resins such as epoxidized linseed oil and epoxidized soybean oil contain aliphatic disubstituted oxiranes, which are not very reactive with most of known epoxy curative systems at ambient temperature.

It is possible to make some commonly used petroleum-derived materials from a bio-based source instead of a petroleum-derived source. One example is the production of alcohols from bio-based sources, commonly referred to as bio-alcohols. Non-limiting examples of alcohols that can be produced from bio-based sources include ethanol, butanol, and pentanol. Bio-alcohols can be reacted with epichlorohydrin to produce a bio-based, epoxide functional material. As mentioned above, epichlorohydrin can also be from a bio-based source, creating potential for partially and completely bio-based epoxy resins. Bio-alcohols can also be reacted with phosphoric acid and phosphoric acid derivatives to create partially and completely bio-based phosphate esters.

The current teachings relate to a curative system that reacts very rapidly with aliphatic, disubstituted oxirane rings at ambient and even sub-ambient temperatures. The use of highly reactive acidic compositions including phosphoric acid and phosphoric acid derivatives allows for the ring opening of these aliphatic, disubstituted oxirane rings. Using phosphoric acid as a curative in a two-part system with epoxy can lead to a large difference in viscosity. Additionally, using phosphoric acid as a curative for epoxy resins can present challenges in application due to its high reactivity and speed of reaction. Therefore, for a practical two-part optionally foaming adhesive, phosphate esters are required. Bio-based, green, two-part optionally foaming products have been developed using bio-based materials in both sides. Epoxidized oil resins derived from any unsaturated oil such as vegetable, nut, and seed oils could be used in the resin side. Acidic phosphorous modified bio-based materials and bio-based carboxylic acids have been used in the curative side. We have developed optionally foaming products with greater than 30% renewable content using bio-based materials in both sides of the two-part composition.

The present disclosure relates to a method for preparation of acidic phosphorous compounds with high renewable carbon content. Esters of phosphoric acid could be derived from bio-based mono/poly epoxies as well as bio-based alcohol/polyols. These esters of phosphoric acid (e.g., phosphoric acid constituents) are formed through various reactions of the abovementioned compounds with phosphoric acid species such as orthophosphoric acid, polyphosphoric acid, and P₂O₅. The functionality of the epoxidized bio-based compound could be 1, 2, 3, or even higher. The average functionality of acidic phosphorous-containing compound should be 2 or higher to make a crosslinked network.

### SUMMARY

The present disclosure relates to a two-part system. The two-part system may address at least some of the needs identified above.

The teachings herein are directed to a curable adhesive formulation comprising one or more epoxy resins, and one or more acidic phosphorous species, wherein at least 30% by weight of the adhesive comprises bio-based materials.

The curable adhesive formulation may comprise an A-side with the one or more epoxy resins, and a B-side with an acidic phosphoric constituent, wherein the adhesive includes at least 30% by weight bio-based materials.

The curable adhesive formulation may comprise an A-side with the one or more epoxy resins, a B-side with an acidic phosphoric constituent, wherein the cured adhesive has an elongation of at least 10% as measured in accordance with ASTM D638-10.

The bio-based materials may comprise or essentially consist of the one or more epoxy resins, and/or the one or more acidic phosphorous species or the acidic phosphoric constituent.

The bio-based carbon content of the bio-based materials may be determined in accordance with testing method ASTM D6866; preferably the bio-based carbon content is at least 10%, more preferably at least 30%, even more preferably at least 50%, still more preferably at least 70%, yet more preferably at least 90%.

The one or more epoxy resins may be bio-based and/or the one or more acidic phosphorous species or the acidic phosphoric constituent may be bio-based.

The bio-based carbon content of (i) the one or more epoxy resins and/or (ii) the one or more acidic phosphorous species or the acidic phosphoric constituent may be determined in accordance with testing method ASTM D6866; preferably the bio-based carbon content is at least 10%, more preferably at least 30%, even more preferably at least 50%, still more preferably at least 70%, yet more preferably at least 90%.

The one or more epoxy resins may be bio-based and include one or more epoxidized unsaturated oils.

The one or more epoxy resins may be bio-based and include one or more cashew nutshell liquid-based epoxy resins, linseed oil-based epoxy resins, castor oil-based epoxy resins, soybean oil-based epoxy resins, sorbitol based-epoxy resins, isosorbide-based epoxy resins, or any combination thereof.

The one or more bio-based epoxy resins may be present in an amount of between about 30% to about 90%, preferably about 40% to about 80%, more preferably about 50% to about 70%, by weight of the curable adhesive formulation or by weight of the A-side of the curable adhesive formulation.

The one or more acidic phosphorous species or the acidic phosphoric constituent include phosphate esters may be preferably selected from the group consisting of ethanol-based phosphate esters, butanol-based phosphate esters, cashew nutshell liquid-based phosphate esters, castor oil-based phosphate esters, cellulose-based phosphate esters, tetrahydrofurfuryl alcohol (THFA)-based phosphate esters, ethylene glycol-based phosphate esters, isosorbide-based phosphate esters, or any combination thereof.

The one or more acidic phosphorous species or the acidic phosphoric constituent may be present in an amount of between about 20% to about 90%, preferably about 40% to about 80%, more preferably about 50% to about 70%, by weight of the curable adhesive formulation or by weight of the B-side of the curable adhesive formulation.

The curable adhesive formulation may include one or more additives.

The A-side of the curable adhesive formulation may include one or more additives including particulate or fibrous additives, preferably recycled rubbers, recycled structural foaming epoxy powders, metal carbonates, minerals, reinforcing fibers, hydrophobic silica, or any combination thereof.

The B-side of the curable adhesive formulation may include one or more additives including minerals, reinforcing fibers, hydrophobic silica, glass microspheres, constituents stable in an acidic medium, or any combination thereof.

The curable adhesive formulation may include an acid which is preferably selected from the group consisting of phosphoric acid, citric acid, acetic acid and any combination thereof, preferably the acid is included in the B-side of the curable adhesive formulation and/or the acid is bio-based.

The one or more acidic phosphorous species and the acidic phosphoric constituent may be identical.

The adhesive may undergo a volumetric expansion of at least 50%.

The cured adhesive may have a peak stress of at least 0.02 MPa.

The adhesive and/or the bio-based materials may have a bio-based content of at least 60%, or even at least 80%, preferably determined in accordance with testing method ASTM D6866.

The A-side may include at least 20%, or even at least 40% by weight of a CNSL-based epoxy resin, a linseed-oil based epoxy resin, or some combination thereof.

The B-side may include at least 40%, or even at least 80% by weight of a CNSL-based epoxy resin, a castor-oil based epoxy resin, or some combination thereof.

The B-side may include a THFA-based phosphate ester.

The B-side may include an epoxidized soybean oil.

### DETAILED DESCRIPTION

The present teachings meet one or more of the above needs by the improved two-part system described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the below description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present disclosure relates to a two-part bio-based system and the method of making these high percentage bio-based materials with greater than 50% renewable organic content, reducing the use of petroleum-derived materials. A renewable source, as mentioned here, means a natural source which can replace itself with natural processes over a short time-period.

As described herein, acidic phosphorous constituents are the constituents produced by the reaction of various materials with certain acidic phosphorous species. Non-limiting examples of acidic phosphorous constituents include the phosphate esters described herein and non-limiting examples of acidic phosphorous species include orthophosphoric acid, polyphosphoric acid, and P₂O₅.

The bio-based epoxy resins used in the A-side of the present teachings may include glycidyl ethers. These glycidyl ethers are formed through reaction of epichlorohydrin with the hydroxyl group of an alcohol/polyol. The alcohol/polyol may be from a bio-based source. The epichlorohydrin used may be bio-based if produced from glycerol, allowing for higher levels of bio-content. The oxirane functionality of the bio-based epoxies could be from 1 to 7, or even higher.

The bio-based epoxy resins used in the A-side of the present teachings may include glycidyl esters. These glycidyl esters are formed through reaction of epichlorohydrin with the carboxyl group of an acidic compound. The acidic compound may be from a bio-based source. The epichlorohydrin used may be bio-based if produced from glycerol, allowing for higher levels of bio-content.

The bio-based epoxy resins used in the A-side of the present teachings may include epoxidized unsaturated oils. The epoxidation reaction takes place at a double bond carbon/carbon site through the oxidation of natural oils with peroxide acids. The unsaturated oil could be from sources such as vegetables, nuts, seeds, and animals. The oil-based epoxies such as epoxidized linseed oil and epoxidized soybean oil could have different numbers of oxirane functionalities. These bio-based epoxies could make different crosslink densities and corresponding physical properties depending on their oxirane functionality as well as the molecular structure.

The first component may contain one or more bio-based epoxy resins including one or more cashew nutshell liquid-based epoxy resins, linseed oil-based epoxy resins, castor oil-based epoxy resins, soybean oil-based epoxy resins, sorbitol based-epoxy resins, isosorbide-based epoxy resins, or any combination thereof. The one or more bio-based epoxy resins may be present in an amount of between about 30% to about 90% by weight of the first component.

The number of commercialized bio-based epoxies currently is limited compared to petroleum-derived epoxies. This could make it difficult for formulators to match the properties of their petroleum-derived two-part epoxy systems. Acidic phosphorous compounds such as phosphoric acid and derivatives, bio-based phosphate esters, and petroleum-derived phosphate esters are highly reactive with bio-based and petroleum-derived epoxies. Therefore, use of limited amounts of petroleum-derived epoxies, petroleum-derived phosphate esters, or any combination thereof could be used to modify the properties. Though this would reduce the bio-based content, the bio-based content could still be high by using bio-based materials in both the A-side and the B-side.

The first component may contain one or additional epoxy resins which could be partly bio-based or petroleum-derived including one or more phenoxy-epoxy dissolutions, carboxyl-terminated butadiene acrylonitrile (CTBN) adducted epoxy resins, reactive diluents, bisphenol A-based resins, bisphenol F-based resins, novolac resins, any number of currently available epoxide functional materials not indicated here, or any combination thereof. The one or more additional epoxy resins may be present in an amount of between about 1% to 40% by weight of the first component. The one or more additional epoxy resins may be used to achieve more desirable physical properties.

The first component may contain one or more additives. The one or more additives may include particulate or fibrous additives, including, but not limited to, recycled rubbers, recycled structural foaming epoxy powder, metal carbonates, minerals, reinforcing fibers, hydrophobic silica, or any combination thereof.

The metal carbonate may include a zinc carbonate, a calcium carbonate, a sodium bicarbonate, any number of commercially available metal and/or bicarbonates not indicated here, or any combination thereof. The calcium carbonate may include a ground calcium carbonate, a precipitated calcium carbonate, or any combination thereof. The calcium carbonate may include an ultra-fine calcium carbonate, a fine calcium carbonate, a medium-fine calcium carbonate, a medium calcium carbonate, a coarse calcium carbonate, or any combination thereof. The two-part system, after mixing the first component and the second component, may foam to an increased volume of between about 50% to 1000%.

Most known epoxy curative systems are non-reactive or slow-reactive with aliphatic disubstituted oxirane rings at ambient temperature. Aliphatic disubstituted oxiranes, those formed by the peroxyacid epoxidation reaction include many low-cost and epoxidized bio-based triglycerides, are among the slow to non-reacting systems with common epoxy curatives, at room temperature. The oxirane groups are unreactive or under-reactive with amine derived curatives. The epoxidized bio-based oils may be cured and crosslinked with carboxylic acids if the average oxirane functionality is greater than two. The reaction between the oxirane groups and the carboxylic acid groups is also very slow compared to the reaction speed between the oxirane groups and acidic phosphorous compounds. The present disclosure relates to acidic phosphorous bio-based ester curatives that react with oxirane groups very rapidly.

The second component may contain one or more acids. The one or more acids may contain at least one or more phosphate esters derived from bio-based epoxies or polyols. The one or more phosphate esters derived from bio-based epoxies or polyols may include ethanol-based phosphate esters, butanol-based phosphate esters, cashew nutshell liquid-based phosphate esters, castor oil-based phosphate esters, cellulose-based phosphate esters, tetrahydrofurfuryl alcohol (THFA)-based phosphate esters, ethylene glycol-based phosphate esters, isosorbide-based phosphate esters, or any combination thereof. The phosphate esters may be present in the second component in an amount of between about 20% to 90% by weight of the second component.

The second component may contain at least one or more additives. The one or more additives may include one or more minerals, reinforcing fibers, hydrophobic silica, core-shell particulate polymers, glass microspheres, or any combination thereof.

The two-part system may contain a total renewable carbon content of greater than 30%, more preferably greater than 60%, and even more preferably greater than 90%.

The two-part system may be a thermoset.

The two-part system may cure at a temperature of between about 0° C. and 60° C. The two-part system may cure at room temperature (i.e., between about 20° C. and 25° C.).

U.S. Pat. No. 10,550,220 illustrates the use of phosphoric acid and phosphate esters for cure-in-place compositions. These compositions are typically employed for a wide range of room-temperature activated systems, such as rigid structural foams, cavity filling, gaskets, and sealants. The benefits of such compositions may include the ability to adhere to a variety of substrates, the inclusion of low volatility organic compounds (VOC's), not being sensitive to the dispensing temperature, not being sensitive to the exact mixing ratio of a two-part system, the ability to tune physical and/or mechanical properties, or any combination thereof. The focus of the current teachings is to extend the range of these systems to include high percentage bio-based compositions with similar chemistry and properties as the above-mentioned applications.

The A-side may include one or more bio-based epoxy resins. The bio-based epoxy resins may include, but are not limited to, cashew nutshell liquid-based epoxy resins, linseed oil-based epoxy resins, castor oil-based epoxy resins, soybean oil-based epoxy resins, sorbitol based-epoxy resins, isosorbide-based resins, any other epoxies derived from bio-based sources, or any combination thereof.

The A-side may include one or more bio-based, monofunctional aromatic and/or aliphatic epoxy resins. The bio-based, monofunctional aromatic epoxy resin may have an epoxy equivalent weight of about 425 g/eq to 575 g/eq, according to ASTM D1652-97. The monofunctional aromatic epoxy resin may have a viscosity, measured at 25° C., of about 40 cP to about 70 cP, according to ASTM D2196. The monofunctional aliphatic epoxy resin may include an epoxidized cardanol. A non-limiting example of a suitable monofunctional aromatic epoxy resin may include Cardolite® NC-513, commercially available from Cardolite Corporation.

The A-side may include one or more bio-based, multifunctional aromatic and/or aliphatic epoxy resins. The bio-based, multifunctional aromatic and/or aliphatic epoxy resins may increase the crosslink density of the reaction product, improve mechanical properties of the reaction product, improve chemical resistance of the reaction product, reduce the viscosity of the two-part system and/or mixed composition, improve the cell structure quality of a foamed reaction product, or any combination thereof. The functionality of the bio-based, multifunctional aromatic and/or aliphatic resin may be about 2 or more, 3 or more, or even 4 or more. The functionality of the multifunctional aromatic and/or aliphatic resin may be about 8 or less, 7 or less, or even 6 or less.

The A-side may contain one or more metal carbonates, where foaming is desired. Where the two-part system includes metal carbonate in the A-side, effective functionality of the B-side may be partially reduced in the mixed composition. This may be due to reaction of the acid of the B-side with the metal carbonates of the A-side to cause foaming. The A-side may include components with increased functionality to compensate for a reduced functionality of the B-side as a result of the metal carbonate reaction. The A-side may be formulated with increased functionality by using reactive ingredients with functionality higher than 2 such as aliphatic multifunctional epoxy resins.

Examples of suitable bio-based multifunctional resins may include, but are not limited to, cashew nutshell liquid-based epoxy resins, linseed oil-based epoxy resins, castor oil-based epoxy resins, sorbitol-based epoxy resins, isosorbide-based epoxy resins, or any combination thereof.

The bio-based, difunctional aromatic epoxy resin may have an epoxy equivalent weight of about 350 g/eq to 500 g/eq. The difunctional aromatic epoxy resin may have a viscosity, measured at 25° C., of about 25,000 cP. The difunctional aromatic epoxy resin may include an epoxidized cardanol. A non-limiting example of a suitable difunctional aromatic epoxy resin may include Cardolite® NC-514, commercially available from Cardolite Corporation.

The bio-based, multifunctional aromatic epoxy resin may have an epoxy equivalent weight of about 550 g/eq to 850 g/eq, according to ASTM D1652-97. The multifunctional aromatic epoxy resin may have a viscosity, measured at 25° C., of about 20,000 cP to about 50,000 cP, according to ASTM D2196. The multifunctional aromatic epoxy resin may include an epoxidized cardanol. A non-limiting example of a suitable multifunctional aromatic epoxy resin may include Cardolite® NC-547, commercially available from Cardolite Corporation.

The bio-based, multifunctional aliphatic epoxy resin may have an epoxy equivalent weight of about 175 g/eq. The multifunctional aliphatic epoxy resin may have a viscosity, measured at 25° C., of about 750 cP. The multifunctional aliphatic epoxy resin may include an epoxidized linseed oil. A non-limiting example of a suitable multifunctional aliphatic epoxy resin may include Epoxol® 9-5, commercially available from ACS Technical Products.

The bio-based, multifunctional aliphatic epoxy resin may have an epoxy equivalent weight of about 550 g/eq to 650 g/eq. The multifunctional aliphatic epoxy resin may have a viscosity, measured at 25° C., of about 300 cP to about 500 cP. The multifunctional aliphatic epoxy resin may include a castor oil glycidyl ether. A non-limiting example of a suitable multifunctional aliphatic epoxy resin may include KF EPIOL-PE 412, commercially available from Kukdo Chemical Co., Ltd.

The bio-based, multifunctional aliphatic epoxy resin may have an epoxy equivalent weight of about 200 g/eq to 300 g/eq. The multifunctional aliphatic epoxy resin may have a viscosity, measured at 25° C., of about 300 cP to about 400 cP. The multifunctional aliphatic epoxy resin may include an epoxidized soybean oil. A non-limiting example of a suitable multifunctional aliphatic epoxy resin may include PLASTHALL® ESO, commercially available from Hallstar.

The bio-based, multifunctional aliphatic epoxy resin may have an epoxy equivalent weight of about 175 g/eq to 190 g/eq. The multifunctional aliphatic epoxy resin may have a viscosity, measured at 25° C., of about 4,000 cP to about 6,000 cP. The multifunctional aliphatic epoxy resin may include a sorbitol poly-glycidyl ether. A non-limiting example of a suitable multifunctional aliphatic epoxy resin may include KF EPIOL-PE 510, commercially available from Kukdo Chemical Co., Ltd.

The bio-based, multifunctional aliphatic epoxy resin may have an epoxy equivalent weight of about 170 g/eq to 190 g/eq, according to KD-AS-001. The multifunctional aliphatic epoxy resin may have a viscosity, measured at 25° C., of about 4,000 cP to about 8,000 cP, according to KD-AS-005. The multifunctional aliphatic epoxy resin may include an isosorbide di-glycidyl ether. A non-limiting example of a suitable multifunctional aliphatic epoxy resin may include KUKDO EPOXY KDBM-1040, commercially available from Kukdo Chemical Co., Ltd.

The bio-based, multifunctional aliphatic epoxy resin may include an epoxy resin adducted with dimer acid. The epoxy resin may be partially defunctionalized as a result of the esterification reaction with dimer acid. A non-limiting example of a suitable dimer acid may include Pripol™ 1017.

The A-side may include one or more additional epoxy resins which could be bio-based or petroleum-derived. The reason for using petroleum-derived epoxy resins is to improve desired properties. The additional epoxy resins may include phenoxy-epoxy dissolutions, carboxyl-terminated butadiene acrylonitrile (CTBN) adducted epoxy resins, reactive diluents, bisphenol A-based resins, bisphenol F-based resins, or any combination thereof. The additional epoxy resin may be present in the A-side in an amount of between about 1% to 40% or more by weight of the A-side.

The two-part system may include one or more epoxy/elastomer adducts. The epoxy/elastomer adduct may be included to impart a plasticization effect to the two-part system or may induce phase separation of the two-part system, and/or modify structural properties of the two-part system such as strength, strain-to-failure, fracture toughness (G1c), peel, adhesion durability, uncured-material integrity (i.e., less likely to stick, break or deform before use), and stiffness. Carboxyl-terminated butadiene-acrylonitrile may be particularly useful for developing adhesion to contaminated surfaces. The contaminated surfaces may include oils such as stamping lubricants typical to the automotive industry.

The elastomer in the adduct may be selected from polysulfide, polybutadiene, polyisoprene, polyisobutylene, isoprene-butadiene copolymer, neoprene, acrylic, natural rubber, carboxyl-terminated butadiene-acrylonitrile, polysiloxane, polyester, urethane prepolymer, nitrile rubber (e.g., a butyl nitrile, such as carboxy-terminated butyl nitrile), butyl rubber, polysulfide elastomer, acrylic elastomer, acrylonitrile elastomers, silicone rubber, polyester rubber, diisocyanate-linked condensation elastomer, styrene butadiene rubber, ethylene-propylene diene rubbers, chlorosulfonated polyethylene, fluorinated hydrocarbons, or any combination thereof. The epoxy/elastomer adduct may include a carboxyl-terminated polymer (e.g., an adducted carboxyl-terminated polymer, an adducted carboxy-terminated butyl nitrile). The epoxy/elastomer adduct may be a dicarboxylic acid. The elastomer compound suitable for the adduct may be a thermosetting elastomer, although not required.

The first component may contain one or more non-liquid additives. The one or more additives may include recycled rubbers, recycled structural foaming epoxy powder, one or more metal carbonates, minerals, reinforcing fibers, hydrophobic silica, or any combination thereof.

The first component may contain recycled rubber particles with the objective of including recycled material content into the composition. The recycled rubber may include one or more micronized rubber powders. The micronized rubber powder may contain at least 40% recycled rubber content. Recycled rubber typically uses end-of-life rubber that has been tested for health and safety as opposed to newly produced rubber, which contributes to environmental pollution and consumption of petroleum-derived raw materials. Though recycled rubber itself is not bio-based, it may replace other petroleum-derived fillers and contribute to the overall environmental consideration of the product.

The first component may contain recycled structural foaming epoxy powder. The recycled structural foaming epoxy powder may include non-solid rubber adduct with structural foam. The recycled structural foaming epoxy powder may include material that is past its shelf life and no longer considered useful for its original purpose. Though recycled structural foam is not bio-based, it may replace other petroleum-derived fillers and contribute to the overall environmental consideration of the product. A non-limiting example of a suitable structural foam is L-5905, commercially available from L&L Products.

The two-part system may foam due to the presence of one or more metal carbonates in the two-part system. The metal carbonate may react with an acid. The metal carbonate may be provided in the A-side. The acid may be provided in the B-side. The metal carbonate may include a zinc carbonate, a calcium carbonate, a sodium bicarbonate, any number of commercially available metal carbonates and/or bicarbonates not indicated here, or any combination thereof.

The calcium carbonate may be provided as a combination of fine and a medium-fine size calcium carbonate. The fine calcium carbonate may provide a uniform and fine cell structure. The combination of fine and medium-fine size calcium carbonates may provide a balance between the foaming and curing and thus structural integrity of the foam.

The reaction product may have a volume expansion of between about 50% to 1000%.

Foaming may begin before the complete reaction of epoxide functional monomers and oligomers. The foaming time of the mixed composition may be about 30 seconds or more, 1 minute or more, 5 minutes or more, or even 10 minutes or more. The foaming time of the mixed composition may be about 2 hours or less, 1 hour or less, or even 30 minutes or less. The foaming time may be the time frame within which the two-part system actively foams.

The calcium carbonate may include an ultra-fine particle size calcium carbonate. The ultra-fine particle size may be about 1 micron to 3 microns, or even more preferably about 2 microns. A non-limiting example of a suitable ultra-fine calcium carbonate may include Hubercarb® Q2, commercially available from Huber Engineered Materials.

The calcium carbonate may include a medium fine particle size calcium carbonate. The medium fine particle size may be about 20 microns to 24 microns, or even more preferably about 22 microns. A non-limiting example of a suitable medium fine particle size calcium carbonate may include Hubercarb® Q200, medium fine, commercially available from Huber Engineered Materials.

The calcium carbonate may include a medium fine particle size calcium carbonate. The medium fine particle size may be about 10 microns to 16 microns, or even more preferably about 13 microns. A non-limiting example of a suitable ultra-fine calcium carbonate may include Hubercarb® Q325, commercially available from Huber Engineered Materials.

The calcium carbonate may include a coarse particle size calcium carbonate. The coarse particle size may be about 200 microns to 800 microns, 300 microns to 700 microns, or even 400 microns to 600 microns. A non-limiting example of a suitable ultra-fine calcium carbonate may include Hubercarb® Q40-200, commercially available from Huber Engineered Materials.

The mineral may include one or more silicate minerals. The silicate mineral may include one or more inosilicates. The inosilicate may include wollastonite. Wollastonite may improve mechanical strength, durability, adhesion, moisture resistance, impact resistance, or any combination thereof. The external shape of an individual crystal or crystal group of the one or more minerals may be acicular. The acicular structure of the mineral with aspect ratios in the range of 9 to 20 may help to improve mechanical strength and durability of the reaction product. The wollastonite may contain small percentages of metal carbonate impurities and may contribute to foam as a result. Non-limiting examples of suitable wollastonite may include NYGLOS® 12 and NYGLOS® 8, commercially available from NYCO Minerals Inc.; and Vansil® HR2000, commercially available from Vanderbilt Minerals, LLC.

Fumed silica, including hydrophobic silica, may be used as a thickening agent or thixotrope for the product. Hydrophobic silica's thixotropic nature allows for it to thicken the material without increasing the difficulty of dispensing material. Hydrophobic silica may also be used as an anti-settling agent to improve the shelf life of the material. Non-limiting examples of suitable hydrophobic silica may include AEROSIL® R 202 commercially available from Evonik Corporation and CAB-O-SIL® TS-530 and TS-720, commercially available from Cabot Corporation.

An organophilic phyllosilicate may be used in place of a hydrophobic silica. An example of a suitable organophilic phyllosilicate may include Garamite-1958, commercially available from BYK-Chemie GmbH.

The B-side may contain one or more bio-based acids, acid anhydrides, epoxy resin/phosphoric acid reaction products, reactive diluents, additives, or any combination thereof. The reactive diluents and/or additives may be optional. The B-side may consist essentially of one or more bio-based acids.

The B-side may contain one or more acids. The acid may be liquid at room temperature. Room temperature, as referred to herein, may mean a temperature of between about 20° C. and 25° C. The acid may contain phosphate esters, phosphoric acid, citric acid, acetic acid, other acidic phosphorous compounds, any acid that is stable with phosphoric acid or phosphate esters, or any combination thereof. The other acidic phosphorous compound may be represented by the following formula, wherein the X- and Y- may independently represent —OH, —OR, or any covalent moiety. R may represent any covalent moiety, preferably an aliphatic, cycloaliphatic or aromatic moiety.

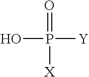

Non-limiting examples of another suitable acid phosphorous compound may include polyphosphoric acid and/or phosphorous acid.

The acid may contain any suitable acid that is stable with and/or will not affect the shelf stability when mixed with phosphoric acid or phosphate ester. The acid may contain at least phosphate ester and optionally phosphoric acid, citric acid, acetic acid, carboxylic acids, other acidic phosphorous compounds, any acid that is stable with phosphoric acid or phosphate ester, or any combination thereof.

The acid may contribute to foaming of the two-part system. That is, the acid may react with metal carbonates (e.g., calcium carbonate) present in the A-side.

The working time of the mixed composition may be tuned by the selection of the acid. Employing phosphate esters instead of phosphoric acid may delay the curing reaction, due to their higher molecular weight, lower functionality, or any combination thereof. The functionality and molecular weight of phosphate esters may be selected to tune the working time.

The B-side may contain one or more phosphate esters, phosphate ester precursors, or both. The B-side may contain one or more phosphate ester precursors that may be combined with phosphoric acid prior to combination with the A-side.

The B-side may contain one or more bio-based phosphate esters. The bio-based phosphate ester may be a reaction product of a mono-epoxide with phosphoric acid under conditions known in the art. This process is described in U.S. Pat. No. 10,550,220.

The bio-based phosphate esters may include a phosphate ester derived from cashew nutshell liquid. The cashew nutshell liquid may be epoxidized. The epoxidized cashew nutshell liquid may be a reaction product of one or more components of cashew nutshell liquid and epichlorohydrin. The one or more components of cashew nutshell liquid may include anacardic acid, cardanol, cardol, or any combination thereof with an aliphatic C10-C20 moiety. The aliphatic C10-C20 moiety may be saturated or unsaturated. The aliphatic C10-C20 moiety may be hydrophobic. The phosphate ester may be a reaction product of epoxidized cashew nutshell liquid and phosphoric acid, as shown below where n is the number of double bonds in the aliphatic chain:

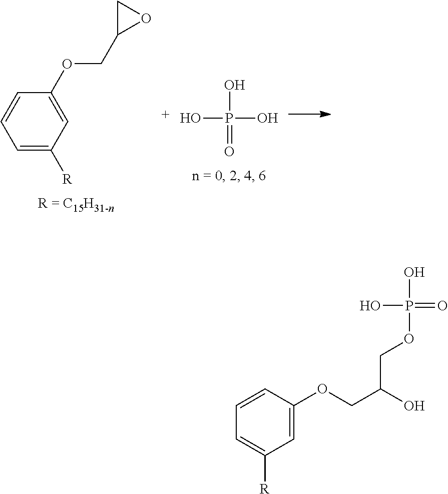

A cardanol-based cashew nutshell liquid is illustrated above but other components of cashew nutshell liquid are contemplated by the present disclosure. A non-limiting example of a suitable epoxidized cashew nutshell liquid may include Cardolite® LITE 2513HP, commercially available from Cardolite Corporation, Monmouth Junction NJ.

The bio-based phosphate esters may be produced from bio-based alcohols using methods known in the art. A similar process is illustrated in a “Commercial Synthesis of Monoalkyl Phosphates” (1).

The bio-based phosphate esters may include a phosphate ester derived from castor oil (1). A non-limiting example of a suitable castor oil may include Castor Oil USP, commercially available from Acme-Hardesty Co.

The bio-based phosphate esters may include a phosphate ester derived from THFA (1). A non-limiting example of a suitable THFA may include 99% THFA, commercially available from Sigma-Aldrich.

The bio-based phosphate esters may include a phosphate ester derived from cellulose (1). A non-limiting example of a suitable cellulosic material may include pulverized wheatgrass, commercially available from WyoComposites, LLC.

The bio-based phosphate esters may include a phosphate ester derived from dimer diols (1). A non-limiting example of a suitable dimer diol may include Pripol™ 2030, commercially available from Croda International, PLC.

The phosphate esters may be produced by a reaction of a range of stoichiometric ratios of phosphate ester precursors to phosphoric acid. The one or more phosphate esters may be produced by a reaction, in a ratio of phosphate ester precursor to phosphoric acid, of about 0.6:1 to 1:0.6, more preferably about 0.7:1 to 1:0.7, or even more preferably about 0.8:1 to 1:0.8. The phosphate ester may be present in an amount between about 40% to 90% by weight of the B-side.

The B-side may include additional phosphoric acid. The additional phosphoric acid may include ortho-phosphoric acid, polyphosphoric acid, or both. The additional phosphoric acid may increase the crosslink density and reduce the open time. Reaction speed of the pre-reacted phosphate esters may be increased by the addition of the additional phosphoric acid in the B-side. The additional phosphoric acid may increase foaming speed and total volume of foaming of the mixed composition.

The phosphoric acid, citric acid, acetic acid, phytic acid, other acidic phosphorous compounds, any acid that is stable with phosphoric acid or phosphate ester, or any combination thereof may be present in the B-side in an amount of between about 30% to 100% by weight of the B-side.

The B-side may contain one or more additives. The one or more additives may include minerals, reinforcing fiber, hydrophobic silica, glass microspheres, any constituent stable in an acidic medium not indicated here, or any combination thereof.

The glass microspheres may be fabricated from fused borosilicate glass. The glass microspheres may be hollow. The glass microspheres may have a bulk density of about 0.1 g/cc to 0.3 g/cc, more preferably 0.2 g/cc to 0.25 g/cc, or even more preferably about 0.22 g/cc. A non-limiting example of a suitable glass microsphere may be Sphericel® 34P30, commercially available from Potters Industries Inc.

A table of organic materials used in either the A-side or B-side can be found below in Table 1. The calculation of bio-based content is expressed in Equation 1 below. The calculation of weight percentage of carbon is expressed in Equation 2 below.

TABLE 1

| | | Bio- | Wt. |
|---|---|---|---|
| | | Based | Per- |
| | | Content | centage |
| Material Name | Description | (%) | of Carbon |
| Cardolite NC-513 | Monofunctional aromatic | 83 | 81 |
| | CNSL-based epoxy resin | | |
| Cardolite NC-514 | Difunctional aromatic | 65 | 78 |
| | CNSL-based epoxy resin | | |
| Cardolite NC-547 | Multifunctional aromatic | 84 | 83 |
| | CNSL-based epoxy resin | | |
| Epoxol 9-5 | Multifunctional aliphatic | 100 | 70 |
| | linseed oil-based epoxy resin | | |
| KF EPIOL-PE 412 | Multifunctional aliphatic | 80 | 72 |
| | castor oil-based epoxy resin | | |
| PLASTHALL ESO | Multifunctional aliphatic | 100 | 71 |
| | soybean oil-based epoxy resin | | |
| KF EPIOL-PE 510 | Multifunctional aliphatic | 30 | 58 |
| | sorbitol-based epoxy resin | | |
| KUKDO EPOXY | Multifunctional aliphatic | 100 | 56 |
| KDBM-1040 | isosorbide-based epoxy resin | | |
| SP-8005 | CTBN modified bisphenol A | 0 | 66 |
| | adduct | | |
| SP-TMEP28ASP | Thermoplastic modified | 0 | Propri- |
| | bisphenol A adduct | | etary* |
| Epoxidized CNSL- | Epoxidized CNSL-based | 86 | 63 |
| based phosphate | phosphate ester | | |
| ester | | | |
| Castor oil-based | Epoxidized castor oil- | 100 | 62 |
| phosphate ester | based phosphate ester | | |
| Tetrahydrofurfuryl | Tetrahydrofurfuryl | 100 | 33 |
| alcohol-based | alcohol-based phosphate | | |
| phosphate ester | ester | | |
| Cellulose-based | Cellulose-based phosphate | 100 | 29 |
| phosphate ester | ester | | |
| Ethylene glycol- | Ethylene glycol-based | 0 | 11 |
| based phosphate | phosphate ester | | |
| ester | | | |
| Epoxidized | Epoxidized ethylhexanol- | 0 | 46 |
| ethylhexanol- | based phosphate ester | | |
| based phosphate | | | |
| ester | | | |

$$Bio based Content = \frac{Wt . Renewable , Organic Carbon ( g )}{Wt . Total Organic Carbon ( g )} . \qquad Equation 1$$

$$Wt . Percentage of Carbon = \frac{\begin{matrix}Molecular Weight of \\ Organic Carbon in Compound ( \frac{g}{m o l} )\end{matrix}}{Total Molecular Weight of Compound ( \frac{g}{m o l} )} . \qquad Equation 2$$

The two-part composition may be mixed in a volumetric ratio of the A-side to the B-side. The volumetric ratio of the A-side to the B-side may be about 2:1.

### EXAMPLES

Table 2 and Table 3 below presents formulations of the two-part system of the present disclosure. The volumetric ratio of the A-side to the B-side was 2:1. These non-limiting bio-based formulations are soft and flexible foaming compositions.

TABLE 2

| | 6 | 12 | 21 | 27 | 29 | 32 | 33 |
|---|---|---|---|---|---|---|---|
| A Side | | | | | | | |
| Cardolite ® NC-513 | 0.00 | 0.00 | 0.00 | 0.00 | 17.54 | 0.00 | 0.00 |
| Cardolite ® NC-514 | 19.00 | 17.54 | 0.00 | 17.75 | 0.00 | 0.00 | 17.54 |
| Cardolite ® NC-547 | 0.00 | 0.00 | 0.00 | 0.00 | 0.00 | 17.54 | 0.00 |
| Epoxol ® 9-5 | 31.00 | 28.62 | 26.72 | 28.97 | 28.62 | 28.62 | 28.62 |
| KF EPIOL-PE 412 | 32.00 | 29.54 | 27.59 | 29.91 | 29.54 | 29.54 | 29.54 |
| Kukdo KDBM-1040 | 0.00 | 0.00 | 16.38 | 0.00 | 0.00 | 0.00 | 0.00 |
| Hubercarb ® Q2 | 7.00 | 14.00 | 12.07 | 13.08 | 14.00 | 14.00 | 14.00 |
| AEROSIL ® R 208 | 2.00 | 2.00 | 1.72 | 1.87 | 2.00 | 2.00 | 2.00 |
| VANSIL ® HR2000 | 9.00 | 8.31 | 15.52 | 8.41 | 8.31 | 8.31 | 8.31 |
| Total | 100.00 | 100.00 | 100.00 | 100.00 | 100.00 | 100.00 | 100.00 |
| B Side | | | | | | | |
| Cashew nutshell | 17.50 | 48.08 | 44.25 | 33.85 | 48.08 | 48.08 | 0.00 |
| liquid-based | | | | | | | |
| phosphate ester | | | | | | | |
| Castor oil-based | 42.00 | 34.62 | 31.86 | 34.62 | 34.62 | 34.62 | 82.70 |
| phosphate ester | | | | | | | |
| THFA-based | 17.50 | 0.00 | 0.00 | 0.00 | 0.00 | 0.00 | 0.00 |
| phosphate ester | | | | | | | |
| Cellulose-based | 0.00 | 0.00 | 0.00 | 20.00 | 0.00 | 0.00 | 0.00 |
| phosphate ester | | | | | | | |
| GARAMITE-1958 | 1.00 | 0.96 | 0.88 | 0.96 | 0.96 | 0.96 | 0.96 |
| VANSIL ® HR2000 | 11.00 | 10.58 | 17.70 | 10.58 | 10.58 | 10.58 | 10.58 |
| H₃PO₄ 85% | 4.00 | 5.77 | 5.31 | 0.00 | 5.77 | 5.77 | 5.77 |
| Total | 100.00 | 100.00 | 100.00 | 100.00 | 100.00 | 100.00 | 100.00 |

TABLE 3

| A Side | 34 | 59 | 60 | 61 | 62 | 63 | 64 |
|---|---|---|---|---|---|---|---|
| Cardolite ® NC-547 | 0.00 | 17.54 | 17.54 | 17.54 | 17.54 | 17.54 | 17.54 |
| Epoxol ® 9-5 | 28.62 | 0.00 | 14.31 | 28.62 | 28.62 | 28.62 | 28.62 |
| KF EPIOL-PE 412 | 29.54 | 25.64 | 29.54 | 29.54 | 29.54 | 29.54 | 29.54 |
| KF EPIOL-PE 510 | 0.00 | 0.00 | 14.31 | 0.00 | 0.00 | 0.00 | 0.00 |
| PLASTHALL ® ESO | 0.00 | 28.62 | 0.00 | 0.00 | 0.00 | 0.00 | 0.00 |
| Hubercarb ® Q2 | 14.00 | 14.00 | 14.00 | 22.31 | 14.00 | 14.00 | 14.00 |
| AEROSIL ® R 208 | 2.00 | 2.00 | 2.00 | 2.00 | 2.00 | 2.00 | 2.00 |
| VANSIL ® HR2000 | 0.00 | 0.00 | 0.00 | 0.00 | 0.00 | 8.31 | 0.00 |
| MicroDyne 75 | 8.31 | 8.31 | 8.31 | 0.00 | 8.31 | 0.00 | 0.00 |
| Recycled Structural | 0.00 | 0.00 | 0.00 | 0.00 | 0.00 | 0.00 | 8.31 |
| Foam | | | | | | | |
| Total | 100.00 | 100.00 | 100.00 | 100.00 | 100.00 | 100.00 | 100.00 |
| B Side | 34 | 59 | 60 | 62 | 62 | 63 | 64 |
| Cashew nutshell | 48.08 | 48.08 | 48.08 | 48.08 | 39.56 | 39.56 | 48.08 |
| liquid-based | | | | | | | |
| phosphate ester | | | | | | | |
| Castor oil-based | 34.62 | 36.62 | 36.62 | 36.62 | 30.13 | 30.13 | 36.62 |
| phosphate ester | | | | | | | |
| Ethylene glycol- | 0.00 | 0.00 | 0.00 | 0.00 | 15.00 | 0.00 | 0.00 |
| based phosphate | | | | | | | |
| ester | | | | | | | |
| THFA-based | 0.00 | 0.00 | 0.00 | 0.00 | 0.00 | 15.00 | 0.00 |
| phosphate ester | | | | | | | |
| AEROSIL ® R 208 | 0.00 | 0.48 | 0.48 | 0.48 | 0.48 | 0.48 | 0.48 |
| GARAMITE-1958 | 0.96 | 0.48 | 0.48 | 0.48 | 0.48 | 0.48 | 0.48 |
| VANSIL ® HR2000 | 10.58 | 10.58 | 10.58 | 7.58 | 10.58 | 10.58 | 10.58 |
| H₃PO₄ 85% | 5.77 | 3.77 | 3.77 | 6.77 | 3.77 | 3.77 | 3.77 |
| Total | 100.00 | 100.00 | 100.00 | 100.00 | 100.00 | 100.00 | 100.00 |

Table 4 shows physical testing results for the formulations of Table 2 and Table 3. Foaming percentage results were obtained by dispensing 100 g of material in a 400 mL beaker and recording starting/final volumes. Tensile testing was performed using 120 mm long dog bones with 10 mm width at the gage length section. The dog bones were 3 mm thick and were tested according to ASTM D638-10 Compression testing was performed using 30 mm by 60 mm cylinders according to ASTM D695. Table 4 also includes an estimate of bio-content percentage, expressed as the percentage of carbon content in a compound that is renewable and expressed in Equation 1.

TABLE 4

| | | Tensile | | Compression | |
|---|---|---|---|---|---|
| | | Peak | | Stress at | Bio- |
| | Expansion | Stress | Elongation | 25% Strain | content |
| Sample | (%) | (MPa) | (%) | (kPa) | (%) |
| 6 | 160 | — | — | — | 83 |
| 12 | 300 | — | — | — | 86 |
| 21 | 50 | — | — | — | 91 |
| 27 | — | 0.07 | 23 | — | 87 |
| 29 | 300 | — | — | — | 89 |
| 32 | 300 | 0.35 | 17 | — | 86 |
| 33 | 75 | — | — | — | 89 |
| 34 | 300 | 0.10 | 14 | — | 86 |
| 59 | 360 | 0.08 | 39 | 1.8 | 89 |
| 60 | 200 | 0.11 | 21 | — | 82 |
| 61 | 400 | 0.18 | 24 | 4.5 | 89 |
| 62 | 135 | 0.35 | 33 | 38 | 89 |
| 63 | 400 | 0.12 | 31 | 7.5 | 86 |
| 64 | 200 | — | — | 40 | 89 |

Table 5 shows formulations of the two-part system according to the present disclosure. As previously mentioned, the addition of petroleum-derived epoxy resins and/or phosphate esters may improve desired properties. Compared to Table 2 and Table 3, the formulations of Table 5 employ a phenoxy-epoxy dissolution in the A-side, a CTBN-adducted epoxy resin in the A-side, an ethylhexylglycerin-based phosphate ester in the B-side, or a combination of these petroleum-derived materials. These additions were made to increase the tensile elongation of the material.

TABLE 5

| A Side | 41 | 50 | 52 |
|---|---|---|---|
| Cardolite ® NC-514 | 17.54 | 0.00 | 0.00 |
| Cardolite ® NC-547 | 0.00 | 15.22 | 15.22 |
| Epoxol ® 9-5 | 28.62 | 24.83 | 24.83 |
| KF EPIOL-PE 412 | 29.54 | 25.64 | 25.64 |
| SP-8005 | 0.00 | 10.00 | 0.00 |
| SP-TMEP28ASP | 0.00 | 0.00 | 10.00 |
| Hubercarb ® Q2 | 14.00 | 14.00 | 14.00 |
| AEROSIL ® R 208 | 2.00 | 2.00 | 2.00 |
| VANSIL ® HR2000 | 8.31 | 0.00 | 0.00 |
| MicroDyne 75 | 0.00 | 8.31 | 8.31 |
| Total | 100.00 | 100.00 | 100.00 |
| B Side | 41 | 50 | 52 |
| Cashew nutshell | 48.08 | 48.08 | 48.08 |
| liquid-based | | | |
| phosphate ester | | | |
| Castor oil-based | 21.62 | 21.62 | 21.62 |
| phosphate ester | | | |
| Ethylhexylglycerin- | 15.00 | 15.00 | 15.00 |
| based phosphate | | | |
| ester | | | |
| GARAMITE-1958 | 0.96 | 0.96 | 0.96 |
| VANSIL ® HR2000 | 10.58 | 10.58 | 10.58 |
| H₃PO₄ 85% | 3.77 | 3.77 | 3.77 |
| Total | 100.00 | 100.00 | 100.00 |

Table 6 shows tensile testing results and bio-content estimations for the formulations of Table 5. These results are in comparison with Sample 32 from Table 2 which includes no additional petroleum-derived epoxy resins or phosphate esters.

TABLE 6

| | Tensile | | |
|---|---|---|---|
| | Peak | | |
| | Stress | Elongation | Bio-content |
| Sample | (MPa) | (%) | (%) |
| 32 | 0.35 | 17 | 86 |
| 41 | 0.35 | 23 | 82 |
| 50 | 0.22 | 45 | 78 |
| 52 | 0.16 | 44 | 75 |

Table 7 shows formulations of the two-part system according to the present disclosure. As previously mentioned, the adhesive is optionally foaming. The formulations in Table 7 include both formulations with and without any of the previously mentioned calcium carbonate particles. Samples 70 and 72 contain no calcium carbonate particles. As a result, Samples 70 and 72 are non-foaming.

TABLE 7

| A Side | 70 | 71 | 72 | 73 |
|---|---|---|---|---|
| Cardolite ® NC-547 | 17.54 | 17.54 | 15.22 | 15.22 |
| Epoxol ® 9-5 | 28.62 | 28.62 | 24.83 | 24.83 |
| KF EPIOL-PE 412 | 29.54 | 29.54 | 25.64 | 25.64 |
| SP-8005 | 0.00 | 0.00 | 10.00 | 10.00 |
| Hubercarb ® Q2 | 0.00 | 14.00 | 0.00 | 14.00 |
| AEROSIL ® R 208 | 2.00 | 2.00 | 2.00 | 2.00 |
| VANSIL ® HR2000 | 8.31 | 22.31 | 8.31 | 22.31 |
| Total | 100.00 | 100.00 | 100.00 | 100.00 |
| B Side | 70 | 71 | 72 | 73 |
| Cashew nutshell | 48.08 | 48.08 | 48.08 | 48.08 |
| liquid-based | | | | |
| phosphate ester | | | | |
| Castor oil-based | 34.62 | 34.62 | 21.62 | 21.62 |
| phosphate ester | | | | |
| Ethylhexylglycerin- | 0.00 | 0.00 | 15.00 | 15.00 |
| based phosphate | | | | |
| ester | | | | |
| GARAMITE-1958 | 0.48 | 0.48 | 0.48 | 0.48 |
| AEROSIL ® R 208 | 0.48 | 0.48 | 0.48 | 0.48 |
| VANSIL ® HR2000 | 10.58 | 10.58 | 10.58 | 10.58 |
| H₃PO₄ 85% | 5.77 | 5.77 | 3.77 | 3.77 |
| Total | 100.00 | 100.00 | 100.00 | 100.00 |

Table 8 shows lap shear testing results and bio-content estimations for the formulations of Table 7. Lap shear testing was performed on 25.4 mm by 101.6 mm, 2 mm thick 6022 aluminum coupons with a 0.5 mm bondline and a 12.7 mm overlap. Testing was performed according to ASTM D1002-10.

TABLE 8

| | Lap Shear | Bio-content |
|---|---|---|
| Sample | Peak Stress (MPa) | (%) |
| 70 | 1.06 | 89 |
| 71 | 1.89 | 89 |
| 72 | 0.56 | 78 |
| 73 | 1.72 | 78 |

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the range in terms of “at least ‘x’ parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. Unless otherwise stated, a teaching with the term “about” or “approximately” in combination with a numerical amount encompasses a teaching of the recited amount, as well as approximations of that recited amount. By way of example, a teaching of “about 100” encompasses a teaching of 100.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

As used herein, the terms “comprising” and “including” may be used interchangeably. This preferably applies with respect to the appended claims.

As used herein, “aliphatic” preferably means a straight or branched hydrocarbon radical containing up to twenty four carbon atoms wherein the saturation between any two carbon atoms is a single, double or triple bond. An aliphatic group preferably contains from 1 to about 24 carbon atoms, more typically from 1 to about 12 carbon atoms with from 1 to about 6 carbon atoms being more preferred.

As used herein, “cycloaliphatic” preferably means a saturated or unsaturated, non-aromatic hydrocarbon moiety having from 1 to 3 rings, each ring having from 3 to 8 (preferably from 3 to 6) carbon atoms.

As used herein, “aromatic” preferably mean a mono- or polycyclic carbocyclic ring system radicals having one or more aromatic rings. Examples of aryl groups include without limitation, phenyl and naphthyl.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A curable adhesive formulation comprising:
(i) an A side with one or more epoxy resins; and
(ii) a B side with one or more acidic phosphorous species;
wherein at least 30% by weight of the adhesive comprises bio-based materials; and
wherein the cured adhesive has an elongation of at least 10% as measured in accordance with ASTM D638-10.

2. The curable adhesive formulation according to claim 1 comprising:
an A-side with the one or more epoxy resins;
a B-side with an acidic phosphoric constituent;
wherein the adhesive includes at least 30% by weight bio-based materials.

3. (canceled)

4. The curable adhesive formulation of claim 1, wherein the bio-based materials comprise or essentially consist of:
(i) the one or more epoxy resins; and/or
(ii) the one or more acidic phosphorous species or the acidic phosphoric constituent.

5. The curable adhesive formulation of claim 1, wherein the bio-based carbon content of the bio-based materials, which preferably comprise or essentially consist of the one or more epoxy resins; and/or the one or more acidic phosphorous species or the acidic phosphoric constituent, is determined in accordance with testing method ASTM D6866; preferably the bio-based carbon content is at least 10%, more preferably at least 30%, even more preferably at least 50%, still more preferably at least 70%, yet more preferably at least 90%.

6. The curable adhesive formulation of claim 1, wherein (i) the one or more epoxy resins are bio-based and/or (ii) the one or more acidic phosphorous species or the acidic phosphoric constituent are bio-based.

7. The curable adhesive formulation of claim 6, wherein the bio-based carbon content of (i) the one or more epoxy resins and/or (ii) the one or more acidic phosphorous species or the acidic phosphoric constituent is determined in accordance with testing method ASTM D6866; preferably the bio-based carbon content is at least 10%, more preferably at least 30%, even more preferably at least 50%, still more preferably at least 70%, yet more preferably at least 90%.

8. The curable adhesive formulation of claim 7, wherein the one or more epoxy resins are bio-based and include one or more epoxidized unsaturated oils.

9. The curable adhesive formulation of claim 6, wherein the one or more epoxy resins are bio-based and include one or more cashew nutshell liquid-based epoxy resins, linseed oil-based epoxy resins, castor oil-based epoxy resins, soybean oil-based epoxy resins, sorbitol based-epoxy resins, isosorbide-based epoxy resins, or any combination thereof.

10. The curable adhesive formulation of claim 8, wherein the one or more bio-based epoxy resins are present in an amount of between about 30% to about 90%, preferably about 40% to about 80%, more preferably about 50% to about 70%, by weight of the curable adhesive formulation or by weight of the A-side of the curable adhesive formulation.

11. The curable adhesive formulation of claim 8, wherein the one or more acidic phosphorous species or the acidic phosphoric constituent include phosphate esters which are preferably selected from the group consisting of ethanol-based phosphate esters, butanol-based phosphate esters, cashew nutshell liquid-based phosphate esters, castor oil-based phosphate esters, cellulose-based phosphate esters, tetrahydrofurfuryl alcohol (THFA)-based phosphate esters, ethylene glycol-based phosphate esters, isosorbide-based phosphate esters, or any combination thereof.

12. The curable adhesive formulation of claim 11, wherein the one or more acidic phosphorous species or the acidic phosphoric constituent is present in an amount of between about 20% to about 90%, preferably about 40% to about 80%, more preferably about 50% to about 70%, by weight of the curable adhesive formulation or by weight of the B-side of the curable adhesive formulation.

13. The curable adhesive formulation of claim 1 including one or more additives.

14. The curable adhesive formulation of claim 13, wherein
the A-side of the curable adhesive formulation includes one or more additives including particulate or fibrous additives, preferably recycled rubbers, recycled structural foaming epoxy powders, metal carbonates, minerals, reinforcing fibers, hydrophobic silica, or any combination thereof; and/or
the B-side of the curable adhesive formulation includes one or more additives including minerals, reinforcing fibers, hydrophobic silica, glass microspheres, constituents stable in an acidic medium, or any combination thereof.

15. The curable adhesive formulation of claim 14 including an acid which is preferably selected from the group consisting of phosphoric acid, citric acid, acetic acid and any combination thereof, preferably the acid is included in the B-side of the curable adhesive formulation and/or the acid is bio-based.

16. The curable adhesive formulation of claim 13, wherein the one or more acidic phosphorous species and the acidic phosphoric constituent are identical.

17. The curable adhesive formulation of claim 13, wherein the adhesive undergoes a volumetric expansion of at least 50%.

18. The curable adhesive formulation of claim 6, wherein the cured adhesive has a peak stress of at least 0.02 MPa.

19. The curable adhesive formulation of claim 13, wherein the adhesive and/or the bio-based materials have a bio-based content of at least 60%, or even at least 80%, preferably determined in accordance with testing method ASTM D6866.

20. The curable adhesive formulation of claim 1, wherein the A-side includes at least 20%, or even at least 40% by weight of a CNSL-based epoxy resin, a linseed-oil based epoxy resin, or some combination thereof.

21. The curable adhesive formulation of claim 1, wherein the B-side includes at least 40%, or even at least 80% by weight of a CNSL-based epoxy resin, a castor-oil based epoxy resin, or some combination thereof.

22. (canceled)

23. (canceled)
